(19) United States
(12) Patent Application Publication
(10) Pub. No.: US 2020/0016679 A1
(43) Pub. Date: Jan. 16, 2020

(54) PRETREATMENT OF WELD FLANGES TO MITIGATE LIQUID METAL EMBRITTLEMENT CRACKING IN RESISTANCE WELDING OF GALVANIZED STEELS

(71) Applicant: GM Global Technology Operations LLC, Detroit, MI (US)

(72) Inventors: Pei-chung Wang, Troy, MI (US); Michael J. Karagoulis, Okemos, MI (US); Spyros P. Mellas, Waterford, MI (US); Zhenke Teng, Troy, MI (US)

(21) Appl. No.: 16/034,712

(22) Filed: Jul. 13, 2018

(51) Int. Cl. B23K 11/16; C23C 4/08; B23K 11/34

(52) U.S. Cl. CPC B23K 11/163; C23C 2/06; B23K 11/34; C23C 4/08

(57) ABSTRACT

A method to mitigate liquid metal embrittlement cracking in resistance welding of galvanized steels includes modifying at least one face of a steel member to create a first workpiece by: applying a zinc containing material in a first layer to the at least one face of the steel member; and spraying a second layer of a copper containing material onto the first layer of the zinc containing material. The at least one face of the first workpiece is abutted to a second workpiece of a steel material. A resistance welding operation is performed to join the first workpiece to the second workpiece. A temperature of the resistance welding operation locally melts the zinc containing material and the copper containing material to create a brass alloy of the zinc containing material and the copper containing material.

### INTRODUCTION

The present disclosure relates to welding, including resistance welding of galvanized steels of ferritic, austenitic, or complex multiple phase microstructure.

Automobile vehicles utilize high strength steel (HSS) such as generation 3 HSS as structural members used for example as load beam reinforcements, B pillar reinforcements, roof rail inner reinforcements, front roof header and bow roof members, panel body side sill reinforcements, reinforcement front and rear rails, and reinforcement floor cross members. The use of HSS in these applications allows predetermined deformation to occur during impact such as during collisions. Generation 3 HSS is herein defined as steel having a tensile strength (MPa)×% elongation 25,000. High strength steel including generation 3 HSS is normally coated with a coating such as zinc to act as a galvanic protective layer to minimize oxidation of the steel. It is desirable to join steel components including generation 3 HSS using rapid welding techniques such as resistance welding, which locally elevates temperatures at the weld sites to approximately 1500 degrees Centigrade or higher. When zinc coated HSS components are welded, liquid zinc which melts at approximately 400 degrees Centigrade interacts with the steel, which together with the strains and stresses from heatup and cooldown of the workpieces occurring during resistance welding can cause liquid metal embrittlement (LME) cracking.

Liquid metal embrittlement, also known as liquid metal induced embrittlement is a phenomenon where certain ductile metals experience drastic loss in tensile ductility or undergo brittle fracture when exposed to specific liquid metals. The practical significance of LME occurs for several steels which experience ductility losses and cracking during hot-dip galvanizing or during subsequent fabrication such as during welding. For example, cracking adjacent to or in the weld joint can occur in HSS galvanized steels during resistance welding when molten zinc of the galvanic protection coating acts to induce cracks in the base steel material.

Thus, while current zinc coated generation 3 HSS components achieve their intended purpose of improving formability and energy absorption, there is a need for a new and improved system and method for pretreatment to mitigate liquid metal embrittlement cracking in resistance welding of galvanized steels.

### SUMMARY

According to several aspects, a method for pretreatment to mitigate liquid metal embrittlement cracking in welding of coated steels, including galvanized, galvannealed, and ZAM (zinc, aluminum, magnesium alloy) steels, includes layering a zinc containing material and a copper containing material on at least one face of a steel member to create a first workpiece. The at least one face of the first workpiece is abutted to a second workpiece of a steel material. A welding operation is performed to join the first workpiece to the second workpiece. A temperature of the welding operation creates an alloy of the zinc containing material and the copper containing material.

In another aspect of the present disclosure, during the layering step the zinc containing material is directly applied onto the steel member and the copper containing material is subsequently applied onto the zinc containing material.

In another aspect of the present disclosure, during the layering step the copper containing material is directly applied onto the steel member and the zinc containing material is subsequently applied onto the copper containing material.

In another aspect of the present disclosure, the method further includes applying the copper containing material using a thermal spraying device.

In another aspect of the present disclosure, the method further includes applying the copper containing material at a temperature above 400 degrees Centigrade.

In another aspect of the present disclosure, the method further includes selecting a copper content of the copper containing material to produce a melting temperature greater than or equal to 400 degrees Centigrade for the alloy of the zinc containing material and the copper containing material.

In another aspect of the present disclosure, the method further includes selecting a substantially pure copper as the copper containing material.

In another aspect of the present disclosure, the method further includes selecting a silicon bronze as the copper containing material.

In another aspect of the present disclosure, the temperature of the resistance welding operation alloys the zinc containing material with the copper containing material to create a brass material alloy.

In another aspect of the present disclosure, the steel member defines a coated steel selected from any one of a mild strength steel, a high strength steel, and an advanced high strength steel including a generation 3 high strength steel.

According to several aspects, a method to mitigate liquid metal embrittlement cracking in resistance welding of coated steels, including galvanized, galvannealed, and ZAM (zinc, aluminum, magnesium alloy) steels includes: modifying at least one face of a steel member to create a first workpiece by: applying a zinc containing material in a first layer to the at least one face of the steel member; and spraying a second layer of a copper containing material onto the first layer of the zinc containing material; abutting the at least one face of the first workpiece to a second workpiece of a steel material; and performing a resistance welding operation to join the first workpiece to the second workpiece wherein a temperature of the resistance welding operation locally melts the zinc containing material and the copper containing material to create a brass alloy of the zinc containing material and the copper containing material.

In another aspect of the present disclosure, the zinc containing material of the first layer defines a zinc alloy further including at least one of: Antimony, Aluminum, Bismuth, Cobalt, Gold, Iron, Lead, Magnesium, Mercury, Nickel, Silver, Sodium, Tellurium, and Tin.

In another aspect of the present disclosure, the method further includes adding to the zinc containing material of the first layer at least one of: gunmetal including copper, tin, and zinc; bronze defining one of Ormolu and Gilt Bronze having copper and zinc; an alloy including copper, aluminum and zinc; an alloy of copper, aluminum, zinc, and tin; a nickel alloy including nickel, copper, and zinc; a solder having zinc, lead, and tin; and a zinc alloy having zinc, aluminum, magnesium, and copper.

In another aspect of the present disclosure, the method further includes modifying at least one face of the second workpiece prior to the abutting step by: applying the zinc containing material in a first layer to at least one face of the second workpiece; and spraying a second layer of the copper containing material onto the first layer of the zinc containing material.

In another aspect of the present disclosure, the method further includes orienting the second layer of the copper containing material of the second workpiece to face the at least one face of the first workpiece during the abutting step.

In another aspect of the present disclosure, the second layer of the copper containing material is applied to a thickness ranging from approximately 0.01 mm up to approximately 0.5 mm inclusive.

In another aspect of the present disclosure, the copper containing material includes a copper content over 90% by composition.

According to several aspects, a welded assembly pretreated to mitigate liquid metal embrittlement cracking in resistance welding of coated steels, including galvanized, galvannealed, and ZAM (zinc, aluminum, magnesium alloy) steels, includes a first workpiece having: a steel member; a zinc containing material defining a first layer applied to at least one face of the steel member; and a copper containing material defining a second layer applied onto the first layer of the zinc containing material. A second workpiece of a steel material is abutted to the at least one face of the first workpiece. A resistance weld joint joining the first workpiece to the second workpiece has a brass alloy of the zinc containing material and the copper containing material created proximate the weld joint by a temperature of the resistance welding operation.

In another aspect of the present disclosure, the steel member defines a generation 3 high strength steel.

In another aspect of the present disclosure, a copper content of the copper containing material is selected to produce a melting temperature greater than or equal to 400 degrees Centigrade for the alloy of the zinc containing material and the copper containing material.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a top plan view of a known resistance welded assembly;

FIG. 2 is a side elevational view of the resistance welded assembly of FIG. 1;

FIG. 3 is a top plan view of the weld joint of resistance welded assembly of FIG. 1 demonstrating a liquid metal embrittlement crack;

FIG. 4 is a cross sectional front elevational view taken at section 4 of FIG. 1;

FIG. 5 is a graph of a copper-zinc binary phase diagram;

FIG. 6 is an assembly flow diagram for the method for pretreatment to mitigate liquid metal embrittlement cracking in resistance welding of galvanized steels of the present disclosure;

FIG. 7 is an assembly flow diagram modified from FIG. 6;

FIG. 8 is a top plan view of a resistance weld joint using the method of the present disclosure; and

FIG. 9 is a cross sectional front elevational view taken at section 9 of FIG. 8.

### DETAILED DESCRIPTION

The following description is merely exemplary in nature and is not intended to limit the present disclosure, application, or uses.

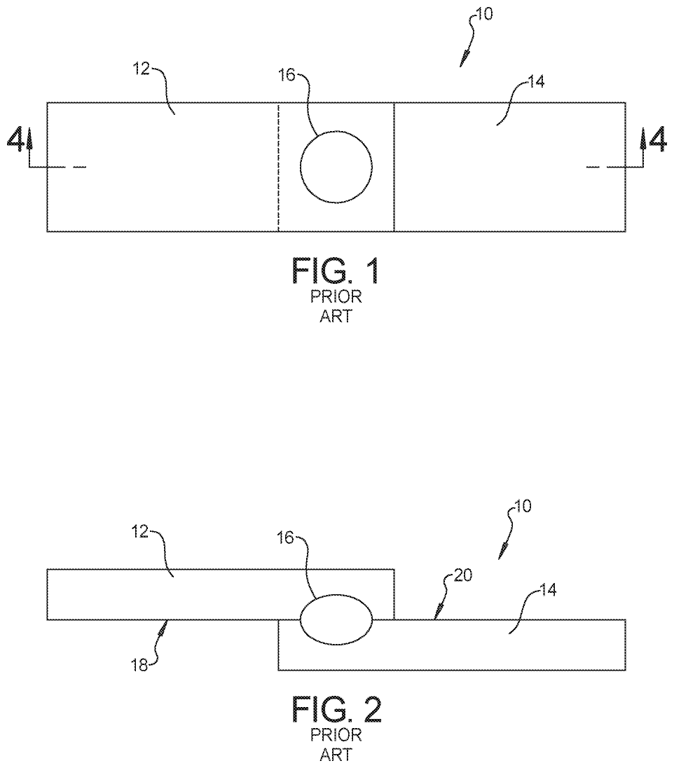

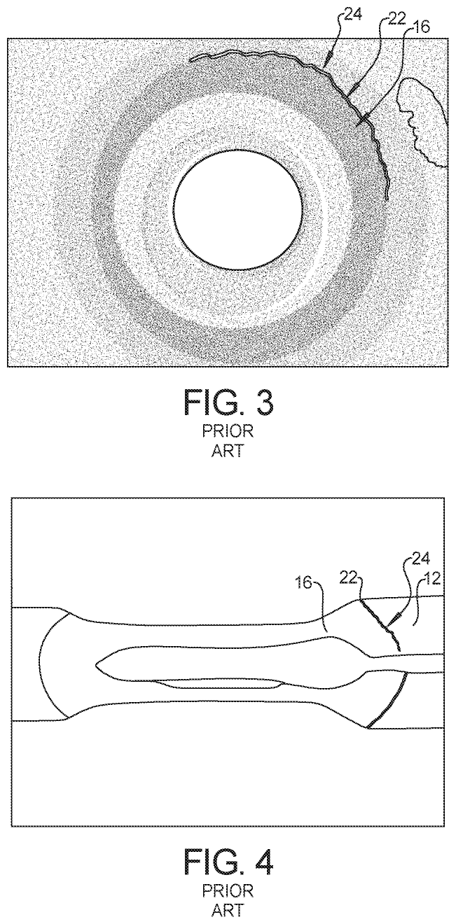

Referring in general to FIGS. 1 through 4, a known assembly 10 is presented having a first metal flange 12 fixed to a second metal flange 14 using a resistance welded joint 16. With specific reference to FIG. 2, any one or both of the first metal flange 12 and the second metal flange 14 can have a predisposed coating of a galvanic material such as zinc. A first zinc layer 18 is applied on the first metal flange 12 and an opposed second zinc layer 20 is applied on the second metal flange 14 prior to a welding operation. With specific reference to FIGS. 3 and 4, a plan view and a cross section of the weld joint 16 indicates the presence of a liquid metal embrittlement crack 22 created at a boundary 24 of the weld joint 16.

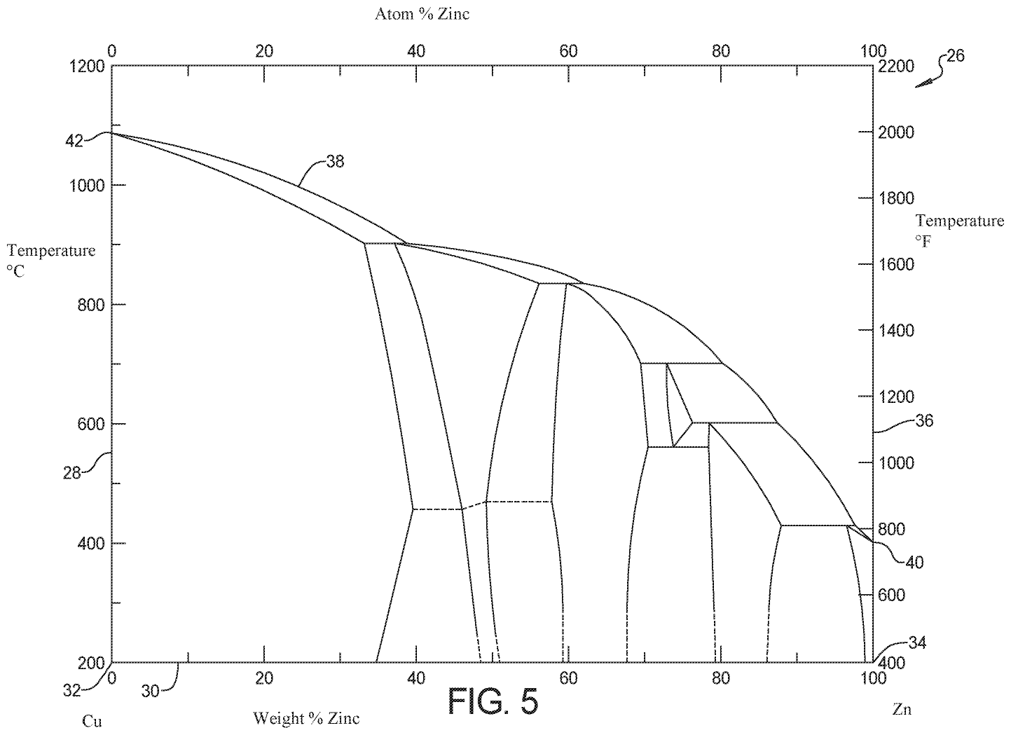

Referring to FIG. 5, a binary phase diagram 26 presents differences in melting temperatures in a degrees Centigrade range 28 versus a composition percentage range 30 varying between a pure copper 32 and a pure zinc 34. The binary phase diagram 26 also presents the same data in a degrees Fahrenheit range 36. A curve 38 identifies a variation in the melting temperature ranging between a first point 40 of approximately 400 degrees Centigrade (pure zinc melts at 419.5 degrees Centigrade) up to a second point 42 of approximately 1100 degrees Centigrade (pure copper melts as 1085 degrees Centigrade).

In accordance with the present disclosure, it has been discovered that by addition of a copper containing layer onto the zinc layer of a galvanized steel material prior to welding, during the subsequent welding process the “free zinc” coating of the zinc layer becomes molten at approximately 400 degrees Centigrade and alloys with copper in the copper alloy layer. This alloying process draws the zinc coating away from a surface of the steel material before the molten zinc has a chance to crack the steel via the liquid metal embrittlement (LME) mechanism. According to the present disclosure, the zinc and copper together alloy to form brass in one of multiple possible brass phases, which raises the melting point from that of zinc above the first point 40 (approximately 400 degrees Centigrade). The increase in melting point together with the alloying process draws away the zinc material from a surface of the steel and prevents LME or significantly reduces LME of the steel. The present method is effective to prevent or significantly reduce LME in relevant automotive steels including when used in coated (e.g., galvanized and galvannealed) HSS steels such as generation 3 HSS.

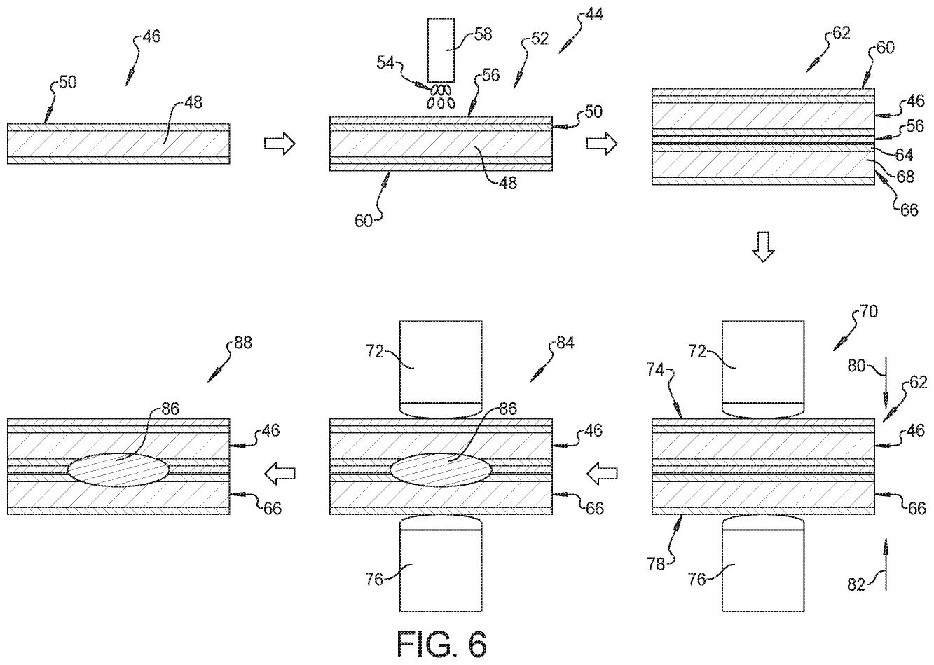

Referring to FIG. 6 and again to FIG. 5, a method to mitigate liquid metal embrittlement cracking in resistance welding of coated steels, including galvanized, galvannealed, and ZAM (zinc, aluminum, magnesium alloy) steels 44 is initiated on a first workpiece 46. According to several aspects, the first workpiece 46 includes a metal sheet 48 made for example of generation 3 HSS. A coating layer 50 of a material such as zinc is pre-applied onto the metal sheet 48 for galvanic protection of the steel base material. The coating layer 50 of zinc material can have a thickness ranging from approximately 0.005 mm up to approximately 0.08 mm inclusive.

In an application step 52 molten droplets of a copper containing material 54 are sprayed or applied onto the coating layer 50 of the workpiece 46, thereby creating a first deposition layer 56. The copper containing material 54 may be applied by additive manufacturing such as by thermal spraying device 58, or can be applied using a mechanical method. The copper containing material 54 may be for example a pure copper or a copper bearing material such as silicon bronze. According to several aspects, a second deposition layer 60 can similarly be formed on an opposite face of the sheet 48 with respect to the first deposition layer 56. Each of the first deposition layer 56 and the second deposition layer 60 have a thickness ranging from approximately 0.01 mm up to approximately 0.5 mm inclusive, however a thickness of the copper containing material 54 added as the first and second deposition layers 56, 60 is not limiting. According to several aspects, the thermal spray application of the copper containing material 54 is conducted at elevated temperature, above the first point 40 of approximately 400 degrees Centigrade, to improve adhesion of the copper or silicon bronze material to the zinc, and to start the binding process of zinc with the copper or silicon bronze prior to the welding operation.

In a subsequent assembly operation, a welding subassembly 62 is created having the workpiece 46 positioned with the first deposition layer 56 (or alternately the second deposition layer 60) brought into direct contact with a zinc coating layer 64 of a second workpiece 66. According to several aspects, the second workpiece 66 includes a metal sheet 68 which can be for example a steel such as but not limited to generation 3 HSS, or a lower strength steel which may or may not be susceptible to the LME mechanism. If both the first workpiece 46 and the second workpiece 66 are high strength steel such as generation 3 HSS material and are susceptible to LME during welding, the outermost layer of either the zinc or the copper material of both workpieces are aligned to face each other to promote alloying of the zinc and copper materials of both workpieces. In a subsequent pre-welding operation 70 a first electrode 72 is brought into direct contact with an outer surface 74 of the first workpiece 46, and a second electrode 76 is brought into direct contact with an oppositely directed second surface 78 of the second workpiece 66. A first force 80 is then applied by the first electrode 72 and an oppositely directed second force 82 is applied by the second electrode 76 to force the first workpiece 46 into abutment with the second workpiece 66.

In a welding step 84 a resistance welding current is applied by the first electrode 72 and across the second electrode 76 through the first workpiece 46 and the second workpiece 66 to create a weld joint 86. During formation of the weld joint 86 the zinc in the coating layer 50 melts and alloys with the copper material of the copper containing material 54 to form a bronze alloy. To minimize the possibility of liquid metal embrittlement by the molten zinc material remaining in contact with the steel material, it is desirable for the melting point of the bronze material alloyed during the welding step 84 to be as close as possible to the second point 42 of approximately 1100 degrees Centigrade for pure copper discussed in reference to FIG. 5. It is therefore advantageous for the copper containing material 54 to have a high copper content, defined as a copper content over 90% by composition such as in silicon bronze. Following the welding step 84 and after cooling of the weld joint 86, a resistance welded assembly 88 is completed.

According to several aspects, in addition to pure copper and silicon bronze, the copper containing material 54 can also include the following as examples of metals that can be combined alone or in combination with the zinc of the coating layer 50 to make “Zinc alloys” of the present disclosure: Antimony, Aluminum, Bismuth, Cobalt, Gold, Iron, Lead, Magnesium, Mercury, Nickel, Silver, Sodium, Tellurium, and Tin. Other acceptable alloys that include Zinc are: Bronze—Gunmetal (copper, tin, zinc); Bronze—Ormolu (Gilt Bronze) (copper, zinc); Devarda's alloy—(copper, aluminum, zinc); Nordic gold—(copper, aluminum, zinc, tin); Nickel alloy—German silver (nickel, copper, zinc); Solder—(zinc, lead, tin); and Zinc alloy—Zamak (zinc, aluminum, magnesium, copper). Silicon Bronze as noted herein may have a composition of approximately 96% Copper, 3% silicon and 1% Manganese.

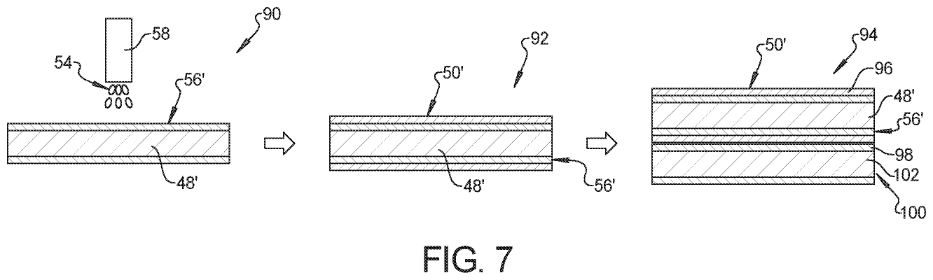

Referring to FIG. 7 and again to FIG. 6, it is noted the material layers applied to create a workpiece 90 are modified from the workpiece 46 by reversing the layers. For example, starting with the metal sheet 48′ made for example of generation 3 HSS, the molten droplets of the copper containing material 54 are sprayed or applied directly onto the metal sheet 48′ such that the first deposition layer 56′ directly contacts the metal sheet 48′. Subsequently, in a coating step 92 the coating layer 50′ of zinc material is applied onto the copper containing material of the first deposition layer 56′. A similar assembly operation creates a welding subassembly 94 similar to the welding subassembly 62. The welding subassembly 94 is created having the metal sheet 48′ positioned with the coating layer 50′ (or alternately an outside facing coating layer 96) brought into direct contact with a zinc coating layer 98 of a second workpiece 100. According to several aspects, the second workpiece 100 includes a metal sheet 102 which can be for example a steel such as but not limited to generation 3 HSS, a lower strength steel or a carbon steel. A pre-welding operation similar to the pre-welding operation 70, and a welding operation similar to the welding step 84 described in reference to FIG. 6 are then performed to create a resistance welded assembly (not shown).

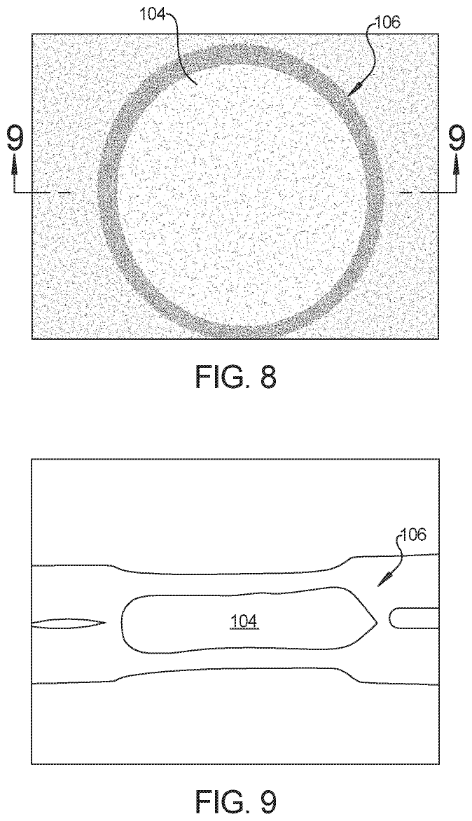

Referring to FIGS. 8 and 9, and again to FIGS. 5 through 7, a weld joint 104 is shown which was created using the method to mitigate liquid metal embrittlement cracking in resistance welding of coated steels, including galvanized, galvannealed, and ZAM (zinc, aluminum, magnesium alloy) steels 44 of the present disclosure. The weld joint 104 exhibits no LME cracking in a weld zone 106 where LME cracks are prevalent in weld joints created using known welding processes such as depicted in reference to FIG. 3.

The method to mitigate liquid metal embrittlement cracking in resistance welding of coated steels, including galvanized, galvannealed, and ZAM (zinc, aluminum, magnesium alloy) steels 44 of the present disclosure offers several advantages. These include the beneficial effect of alloying the zinc coating with another material, e.g., silicon bronze, copper, or the like, so the zinc element does not penetrate into the grain boundaries of the steel to form LME cracks during resistance welding of galvanized steels. The alloying process can also advantageously begin between the zinc in the galvanized coating and the silicon bronze, or the copper during the thermal spraying process prior to resistance welding. The alloying process also occurs between the zinc in the galvanized coating with silicon bronze or copper alloy during the resistance welding process.

Although the present disclosure is described in reference to resistance welding, the method of the present disclosure can also be applied to all fusion welding processes, including arc welding processes, laser welding processes and the like. The method of the present disclosure is also applicable for fusion welding of multiple workpieces.

The description of the present disclosure is merely exemplary in nature and variations that do not depart from the gist of the present disclosure are intended to be within the scope of the present disclosure. Such variations are not to be regarded as a departure from the spirit and scope of the present disclosure.

1. A method for pretreatment to mitigate liquid metal embrittlement cracking for welding of coated steels, including galvanized, galvannealed, and ZAM (zinc, aluminum, magnesium alloy) steels, comprising:
layering a zinc containing material and a copper containing material on at least one face of a steel member to create a first workpiece;
abutting the at least one face of the first workpiece to a second workpiece of a steel material; and
performing a welding operation to join the first workpiece to the second workpiece wherein a temperature of the welding operation creates an alloy of the zinc containing material and the copper containing material.

2. The method of claim 1, wherein during the layering step the zinc containing material is directly applied onto the steel member and the copper containing material is subsequently applied onto the zinc containing material.

3. The method of claim 1, wherein during the layering step the copper containing material is directly applied onto the steel member and the zinc containing material is subsequently applied onto the copper containing material.

4. The method of claim 1, further including applying the copper containing material using thermal spraying device.

5. The method of claim 1, further including applying the copper containing material at a temperature above 400 degrees Centigrade.

6. The method of claim 1, further including selecting a copper content of the copper containing material to produce a melting temperature greater than or equal to 400 degrees Centigrade for the alloy of the zinc containing material and the copper containing material.

7. The method of claim 1, further including selecting a substantially pure copper as the copper containing material.

8. The method of claim 1, further including selecting a silicon bronze as the copper containing material.

9. The method of claim 1, wherein the temperature of the resistance welding operation alloys the zinc containing material with the copper containing material to create a brass or other alloy containing both copper and zinc.

10. The method of claim 1, wherein the steel member defines a coated steel selected from any one of a mild strength steel, a high strength steel, and an advanced high strength steel including a generation 3 high strength steel.

11. A method to mitigate liquid metal embrittlement cracking in resistance welding of coated steels, including galvanized, galvannealed, and ZAM (zinc, aluminum, magnesium alloy) steels, comprising:
modifying at least one face of a steel member to create a first workpiece by:
applying a zinc containing material in a first layer to the at least one face of the steel member; and
spraying a second layer of a copper containing material onto the first layer of the zinc containing material;
abutting the at least one face of the first workpiece to a second workpiece of a steel material; and
performing a resistance welding operation to join the first workpiece to the second workpiece wherein a temperature of the resistance welding operation locally melts the zinc containing material and the copper containing material to create a brass alloy of the zinc containing material and the copper containing material.

12. The method of claim 11, wherein the zinc containing material of the first layer defines a zinc alloy further including at least one of: Antimony, Aluminum, Bismuth, Cobalt, Gold, Iron, Lead, Magnesium, Mercury, Nickel, Silver, Sodium, Tellurium, and Tin.

13. The method of claim 11, further including adding to the zinc containing material of the first layer at least one of:
gunmetal including copper, tin, and zinc;
bronze defining one of Ormolu and Gilt Bronze having copper and zinc;
an alloy including copper, aluminum, and zinc;
an ahoy of copper, aluminum, zinc, and tin;
a nickel alloy including nickel, copper, and zinc;
a solder having zinc, lead, and tin; and
a zinc alloy having zinc, aluminum, magnesium, and copper.

14. The method of claim 11, further including:
modifying at least one face of the second workpiece prior to the abutting step by:
applying the zinc containing material in a first layer to at least one face of the second workpiece; and
spraying a second layer of the copper containing material onto the first layer of the zinc containing material.

15. The method of claim 14, further including orienting the second layer of the copper containing material of the second workpiece to face the at least one face of the first workpiece during the abutting step.

16. (canceled)

17. The method of claim 11, wherein the copper containing material includes a copper content over 90% by composition.

18. A welded assembly pretreated to mitigate liquid metal embrittlement cracking for resistance welding of coated steels, including galvanized, galvannealed, and ZAM (zinc, aluminum, magnesium alloy) steels, comprising:
a first workpiece having:
a steel member;
a zinc containing material defining a first layer applied to at least one face of the steel member; and
a copper containing material defining a second layer applied onto the first layer of the zinc containing material;
a second workpiece of a steel material abutted to the at least one face of the first workpiece; and
a resistance weld joint weld performed in a resistance welding operation joining the first workpiece to the second workpiece having a brass alloy of the zinc containing material and the copper containing material created proximate the weld joint by a temperature of the resistance welding operation.

19. The welded assembly of claim 18, wherein the steel member defines a generation 3 high strength steel.

20. The welded assembly of claim 18, wherein a copper content of the copper containing material is selected to produce a melting temperature greater than or equal to 400 degrees Centigrade for the alloy of the zinc containing material and the copper containing material.

21. A welded assembly pretreated to mitigate liquid metal embrittlement cracking for resistance welding of coated steels, including galvanized, galvannealed, and ZAM (zinc, aluminum, magnesium alloy) steels, comprising:
a first workpiece having:
a steel member;
a zinc containing material defining a first layer applied to at least one face of the steel member; and
an alloying metal material defining a second layer applied onto the first layer of the zinc containing material, the alloying metal material containing at least one of the following: copper, antimony, aluminum, bismuth, cobalt, gold, iron, lead, magnesium, mercury, nickel, silver, sodium, tellurium, and tin;
a second workpiece of a steel material abutted to the at least one face of the first workpiece; and
a weld joint joining the first workpiece to the second workpiece, the weld joint formed of an alloy of the zinc containing material and the alloying metal material.
